(19) United States
(12) Patent Application Publication
(10) Pub. No.: US 2026/0136111 A1
(43) Pub. Date: May 14, 2026

(54) ROLE CONTROL APPARATUS, ROLE CONTROL METHOD, AND IMAGE CAPTURE CONTROL SYSTEM

(71) Applicant: CANON KABUSHIKI KAISHA, Tokyo (JP)

(72) Inventor: MASAYUKI ISHIZAWA, Kanagawa (JP)

(21) Appl. No.: 19/376,133

(22) Filed: Oct. 31, 2025

(30) Foreign Application Priority Data
Nov. 11, 2024 (JP) 2024-196926

(51) Int. Cl. H04N 23/90; H04N 23/61; H04N 23/63; H04N 23/661; H04N 23/69

(52) U.S. Cl. CPC H04N 23/90; H04N 23/61; H04N 23/631; H04N 23/662; H04N 23/69

(57) ABSTRACT

A role control apparatus that controls operation of a physical camera in accordance with a role set thereto, is disclosed. The role control apparatus generates first information indicating a correspondence between a plurality of virtual cameras and respective roles set thereto and third information indicating definitions of the roles.

### BACKGROUND

### Field of the Technology

The present disclosure relates to a role control apparatus, a role control method, and an image capture control system, and in particular relates to a technique for automatically controlling operations of image capture apparatuses.

### Description of the Related Art

Japanese Patent Laid-Open No. 2020-25248 discloses an image capture system in which a plurality of cameras are divided into a main camera and sub cameras, and the sub cameras are controlled to capture images of the same object as an object that is captured by the main camera.

In the image capture system described in Japanese Patent Laid-Open No. 2020-25248, image capturing performed by the sub cameras can be automatically controlled, thereby enabling realization of labor saving.

### SUMMARY

In the image capture system described in Japanese Patent Laid-Open No. 2020-25248, a camera closer to the object is automatically set as the main camera. Thus, there has been room for improvement in terms of the degree of freedom in setting the main camera and the sub cameras in accordance with the user's intention. In view of this, the present disclosure, in one aspect thereof, provides a role control apparatus and a role control method for improving the degree of freedom in camera setting relating to automatic image capture control.

According to an aspect of the present disclosure, there is provided a role control apparatus that controls operation of a physical camera in accordance with a role set thereto, the role control apparatus comprising one or more processors that execute a program stored in a memory and thereby function as units including: a first generation unit configured to generate first information indicating a correspondence between a plurality of virtual cameras and respective roles set thereto; and a second generation unit configured to generate third information indicating definitions of the roles.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an overall configuration example of an image capture system according to an embodiment of the present disclosure.

FIGS. 2A and 2B are diagrams showing an example of a settings screen presented by a role control apparatus according to the embodiment.

FIGS. 3A and 3B are diagrams illustrating an example of settings information according to the embodiment.

FIGS. 4A and 4B are diagrams illustrating an example of settings information according to the embodiment.

FIG. 5 is a flowchart related to processing that is executed by the role control apparatus according to the embodiment.

FIG. 6 is a flowchart related to processing that is executed by the role control apparatus according to the embodiment.

FIG. 7 is a flowchart related to processing that is executed by the role control apparatus according to the embodiment.

FIGS. 8A and 8B are diagrams showing an example of a control operation that is based on role settings.

FIGS. 9A and 9B are diagrams showing another example of the control operation that is based on role settings.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

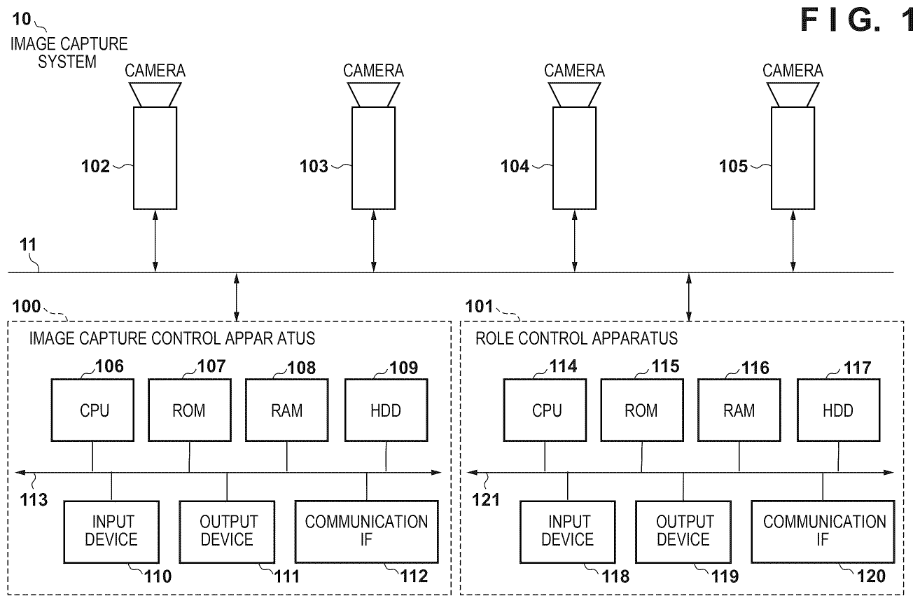

FIG. 1 is a diagram showing an example of an overall configuration of an image capture system 10 according to the present embodiment. The image capture system 10 includes an image capture control apparatus 100, a role control apparatus 101, and cameras 102, 103, 104, and 105. The cameras 102 to 105, the image capture control apparatus 100, and the role control apparatus 101 are connected to each other in a communication-enabling manner via a communication network 11.

The communication network 11 conforms to known wired or wireless communication standards such as the IEEE 802.3 series and the IEEE 802.11 series. Each of the cameras 102 to 105, the image capture control apparatus 100, and the role control apparatus 101 has a communication interface conforming to the standards of the communication network 11.

The cameras 102 to 105 are, for example, PTZ cameras, and operations thereof including image capture directions (pan and tilt angles) and angles of view (zoom) can be controlled from an external apparatus. In the present embodiment, only four cameras are illustrated, but the number of cameras is not limited thereto. In addition, at least one of the cameras 102 to 105 may have a configuration in which an image capture direction (pan and tilt angles) is controllable by mounting the camera body on a platform. In addition, at least one of the cameras 102 to 105 may have a configuration in which an interchangeable zoom lens is attached to the camera body.

Note that FIG. 1 illustrates a configuration in which all signals are transmitted and received via the communication network 11, but, for example, video signals and control signals may be transmitted and received by different methods. For example, each of the plurality of cameras 102 to 105 may directly supply a video signal to the image capture control apparatus 100 using a cable. The cameras 102 to 105 and the image capture control apparatus 100 each have a communication circuit conforming to the standard of video signals. Examples of the standard of the video signal include the serial digital interface (SDI) standard and the high-definition multimedia interface (HDMI) (registered trademark), but are not limited thereto.

The image capture control apparatus 100 analyzes video signals received from the cameras 102 to 105 and detects a predetermined type of object (such as a face or a human body). Based on information obtained from a main camera among the cameras 102 to 105 and a role set to each sub camera, the image capture control apparatus 100 determines the image capture direction and angle of view of the sub camera. The image capture control apparatus 100 then transmits a control command including the determined image capture direction and angle of view to the sub camera. By changing the role set to the sub camera, it is possible to change the method for determining the image capture direction and angle of view of the sub camera based on the information obtained from the main camera, and thus it is possible to increase the degree of freedom in controlling the operation of the sub camera.

The role control apparatus 101 manages definitions of roles to be set to cameras and manages roles set to cameras. Among the plurality of cameras, one is set as a main camera and the remaining cameras are set as sub cameras, and for the sub cameras, types of methods for determining an image capture direction and angle of view (control methods) are further set. Note that, in addition to the main camera and the sub cameras, a fixed camera may also be set.

In the present embodiment, the operation of each sub camera is controlled in accordance with information related to the main camera and the role set to the sub camera. By selectively setting, to each sub camera, one of a plurality of roles respectively corresponding to different control methods, the operation of the sub camera can be flexibly controlled. Examples of specific roles and control methods, and the operation of the role control apparatus 101 will be described later in detail.

### Hardware Configuration of Image Capture Control Apparatus 100

Next, an example hardware configuration of the image capture control apparatus 100 will be described. The image capture control apparatus 100 may be a general-purpose computer device such as a personal computer or a workstation. The image capture control apparatus 100 has a configuration in which a CPU 106, a ROM 107, a RAM 108, an HDD 109, an input device 110, an output device 111, and a communication interface (IF) 112 are connected to each other via an internal bus 113.

The CPU 106 is a microprocessor capable of executing programmed instructions. The CPU 106 controls the operations of components of the image capture control apparatus 100, and realizes functions of the image capture control apparatus 100, for example, by loading a program stored in the ROM 107 to the RAM 108 and executing the program. The CPU 106 can realize the functions of the image capture control apparatus 100, for example, by executing an image capture control application that runs on an operating system (OS).

The ROM 107 is a rewritable non-volatile memory, and stores programs (an OS and applications) that are executed by the CPU 106, user data, and/or the like.

The RAM 108 is used for loading a program to be executed by the CPU 106 and temporarily storing data to be processed by the CPU 106, data that is being processed, and/or the like.

The hard disk drive (HDD) 109 is an example of a device that stores data and programs used in the image capture control apparatus 100. In place of the HDD, an SSD or a device that uses a removable medium may be used. The storage device may be an external apparatus connected to the image capture control apparatus 100 in a communication-enabling manner.

The input device 110 is an input device that includes a mouse, a keyboard, a touch panel, and/or the like. The image capture control apparatus 100 accepts an instruction from the user via the input device 110.

The output device 111 may be a liquid crystal display (LCD), for example. The output device 111 displays a GUI screen (and/or the like) provided by a program (OS and application) executed by the image capture control apparatus 100.

A communication interface (IF) 112 is an interface for connecting the image capture control apparatus 100 to the communication network 11. The image capture control apparatus 100 (the CPU 106) can communicate, via the communication IF 112, with external apparatuses on the communication network 11, such as the cameras 102 to 105 and the role control apparatus 101. Note that the image capture control apparatus 100 may also have a communication interface (USB, Bluetooth (registered trademark), or the like) for communicating with external apparatuses without using the communication network 11.

The CPU 106 of the image capture control apparatus 100 automatically controls the operations (image capture directions, angles of view, object tracking, and/or the like) of cameras set a role for a sub camera, from among the cameras 102 to 105, in accordance with the roles set to the respective cameras 102 to 105. Detailed descriptions thereof will be given later.

### Hardware Configuration of Role control Apparatus 101

An example hardware configuration of the role control apparatus 101 will be described. The role control apparatus 101 may be a general-purpose computer device such as a personal computer or a workstation. The role control apparatus 101 has a configuration in which a CPU 114, a ROM 115, a RAM 116, an HDD 117, an input device 118, an output device 119, and a communication interface (IF) 120 are connected to each other via an internal bus 121.

The CPU 114 is a microprocessor capable of executing programmed instructions. The CPU 114 controls the operations of components of the role control apparatus 101 and realizes later-described functions of the role control apparatus 101, for example, by loading a program stored in the ROM 115 to the RAM 116 and executing the program. The CPU 114 can realize the functions of the role control apparatus 101, for example, by executing a role control application that runs on an operating system (OS).

The ROM 115 is a rewritable non-volatile memory, and stores programs (an OS and applications) that are executed by the CPU 114, user data, and/or the like.

The RAM 116 is used for loading a program to be executed by the CPU 114 and temporarily storing data to be processed by the CPU 114, data that is being processed, and/or the like.

The hard disk drive (HDD) 117 is an example of a device that stores data and programs used in the role control apparatus 101. In place of the HDD, an SSD or a device that uses a removable medium may be used. The storage device may also be an external apparatus connected to the role control apparatus 101 in a communication-enabling manner.

The input device 118 is an input device that includes a mouse, keyboard, a touch panel, and/or the like. The role control apparatus 101 accepts an instruction from the user via the input device 118.

The output device 119 may be a liquid crystal display (LCD), for example. The output device 119 displays a GUI screen (and/or the like) provided by a program (OS and application) executed by the role control apparatus 101.

A communication interface (IF) 120 is an interface for connecting the role control apparatus 101 to the communication network 11. The role control apparatus 101 (the CPU 114) can communicate, via the communication IF 120, with external apparatuses on the communication network 11, such as the cameras 102 to 105 and the image capture control apparatus 100. Note that the role control apparatus 101 may also have a communication interface (USB, Bluetooth (registered trademark), or the like) for communicating with external apparatuses without using the communication network 11.

The CPU 114 of the role control apparatus 101 sets a role for a main camera or a sub camera for each of the cameras 102 to 105. In addition, for the roles for the sub cameras, the CPU 114 also sets how the operations of the sub cameras are to be controlled by the image capture control apparatus 100. In particular, in the present embodiment, by associating roles set in advance to virtual cameras with the physical cameras 102 to 105, it is possible to set roles in an environment where the physical cameras 102 to 105 do not exist, or are not yet present. Operation related to role setting performed by the role control apparatus 101 will be described later in detail. Roles may be set to the physical cameras 102 to 105 or to the virtual cameras, or to both the physical cameras 102 to 105 and the virtual cameras. In some embodiments, the physical cameras 102 to 105 can be operated in accordance with their respective role, but the virtual cameras cannot be operated in accordance with their respective role.

### GUI Screen of Role Settings Application

As described above, in the present embodiment, the operation of a sub camera is controlled by a control method corresponding to a role set to the sub camera, thereby enabling flexible control of the operation of the sub camera. On the other hand, considering that, typically, at an image capture site, devices constituting an image capture system are installed and wired, cameras are registered in the image capture system, and then various settings are performed, it is expected that setup at the image capture site requires a longer time due to flexible control being enabled.

Therefore, in the present embodiment, roles are set in advance to virtual cameras corresponding to physical cameras to be installed at a site, and content set for the virtual cameras is applied to the corresponding physical cameras at the image capture site, thereby reducing the time and effort required for setup at the image capture site. The physical cameras are real, tangible cameras capable of capturing images, while the virtual cameras are virtual cameras having no physical entity.

In the present embodiment, specifically, using a role settings application that runs on the role control apparatus 101, first information indicating the relationship between virtual cameras and roles set thereto is generated. Then, for example, in a state where the role control apparatus 101 is incorporated into the image capture system at the image capture site, second information indicating the correspondence relationship between physical cameras registered in the image capture system and the virtual cameras is generated using the role settings application. The role control apparatus 101 then transmits the generated first information and second information to the image capture control apparatus 100.

The image capture control apparatus 100 then specifies roles set to the respective cameras in the image capture system based on the first information and second information received from the role control apparatus 101, and controls the operations of the cameras in accordance with the specified roles.

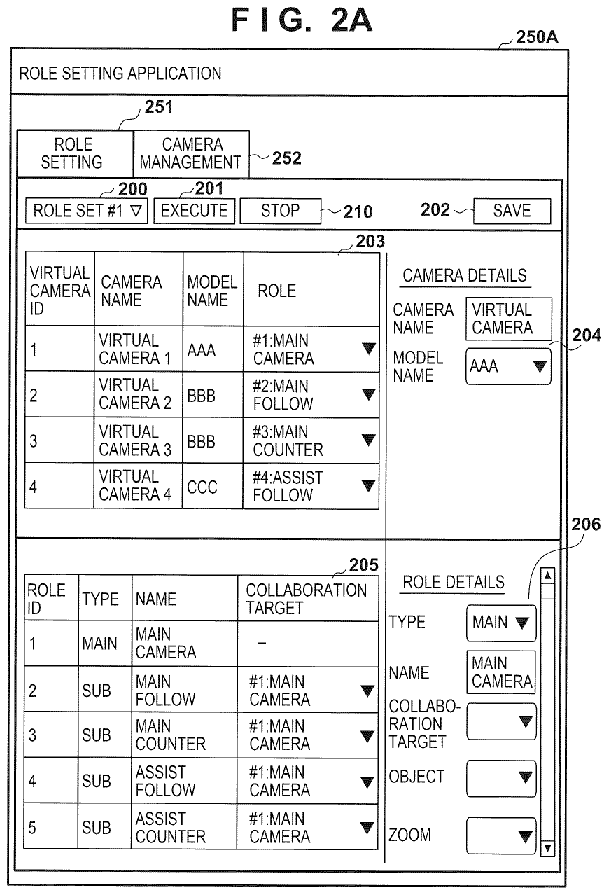

FIGS. 2A and 2B each show an example of a GUI screen displayed on the output device 119 as a result of the CPU 114 of the role control apparatus 101 executing the role settings application. On the GUI screen, display content can be switched using a role setting tab 251 and a camera management tab 252. Hereinafter, the state in which the role setting tab 251 is selected as shown in FIG. 2A is referred to as a role setting screen 250A, and the state in which the camera management tab 252 is selected as shown in FIG. 2B is referred to as a camera management screen 250B.

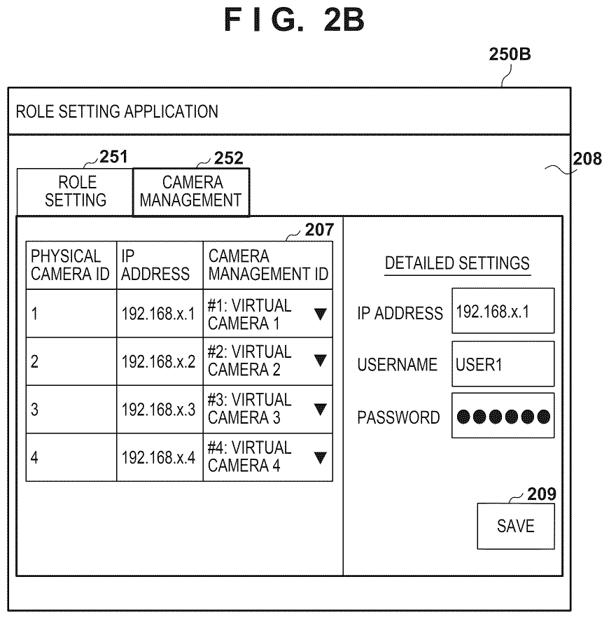

First, the role setting screen 250A will be described. The role setting screen 250A is a screen for setting roles for virtual cameras. Here, types of roles that can be set to sub cameras in the present embodiment, and control content for each type of role will be described. The control content for each type of role (a role definition list, third information) can be stored, for example, in a table format shown in FIG. 3A, in the ROM 115 of the role control apparatus 101 and the ROM 107 of the image capture control apparatus 100.

A role is information indicating whether a camera is a main camera or a sub camera, and indicating, in the case of a sub camera, what type of automatic control is to be performed by the image capture control apparatus 100 (control content). FIG. 3A shows an example of the role definition list in a case where the image capture control apparatus 100 controls an object to be tracked by each sub camera and a zoom operation thereof based on an object to be tracked by a camera set as a collaboration target and a zoom operation thereof. However, the control content of the sub camera controlled by the image capture control apparatus 100 is not limited to an object to be tracked and a zoom operation.

In FIG. 3A, five types of roles are defined, but it suffices for the number of roles to be two or more, including types “main” and “sub”. A role ID is an identifier of a role and is an integer of 1 or greater.

A type is a classification of a camera in automatic control, and, here, two types “main” and “sub” are illustrated. The role for the type “main” is basically set to a single camera (main camera) in the image capture system. Cameras set the roles for the type “sub” (sub cameras) are controlled to operate in collaboration with a camera set as a collaboration target. In the example of the role definition list shown in FIG. 3A, for all roles for the type “sub”, the main camera is set as the collaboration target. Thus, all the sub cameras are controlled to operate in collaboration with the main camera.

Note that the “main camera” is not a specific camera but rather a camera set the role for the type “main”. By setting a collaboration target camera based on a role type in this manner, when a physical camera set the type “main” is changed, the image capture control apparatus 100 controls the operations of the sub cameras to operate in collaboration with the new main camera without changing the “collaboration target” item. In other words, even if the physical camera set as the collaboration target is changed, the same role definition list as before the change can be used.

Note that the role types are not limited to the two types “main” and “sub”. For example, types such as “fixed” and “auto-tracking” may also be included. A camera set a role for the type “fixed” is a camera that does not collaborate with the other cameras and whose angle of view and/or image capture direction is fixed. In addition, a camera set a role for the type “auto-tracking” is a camera that does not collaborate with other cameras and automatically tracks a specific object determined by the camera itself in accordance with predetermined conditions.

A “name” is a title of a role determined such that the user can easily identify a combination of a type and control content. A name is used along with a role ID on a screen (and/or the like) as information for specifying the set role.

The “collaboration target”, “object (image capture target)”, “zoom”, “object position”, and “tracking sensitivity” items are items specific to the roles for the type “sub”, and correspond to the control content of each sub camera.

The “collaboration target” item designates which camera the sub camera is to be controlled to collaborate with. Here, rather than a specific camera, the camera set the role for the type “main” is designated as the collaboration target, but a specific camera may be designated.

The “object” item is an item that designates a type of object to be tracked by the sub camera. For example, each sub camera for which “same as collaboration target” is set is controlled to track the object of interest of the collaboration target camera. If “different from collaboration target” is designated, the position of an object to be tracked is designated relative to the object of interest of the collaboration target camera. Assume that, in this case, an object to the left of (on the left side relative to) or to the right of (on the right side relative to) the object of interest of the collaboration target camera can be designated.

The “zoom” item is an item that designates, when a zoom operation is performed by the camera designated as the collaboration target, how the zoom of the sub camera is coordinated. Each sub camera for which “same direction as collaboration target” is designated is controlled to zoom in the same direction as a zoom operation of the camera designated as the collaboration target. Each sub camera for which “opposite direction to collaboration target” is designated is controlled to zoom in the opposite direction to a zoom operation of the camera designated as the collaboration target.

The “object position” item is an item that roughly designates the position of an object designated by the “object” item, on the screen. The image capture direction of each sub camera for which “center” is designated is controlled such that the object designated by “object” is positioned in the vicinity of the center of the screen by performing pan/tilt operations. Similarly, the image capture direction of each sub camera for which “left” (“right”) is designated is controlled such that the object designated by “object” is positioned on the left (right) side of the screen relative to the center by performing pan/tilt operations. Assume that the degree of deviation from the center is determined in advance.

The “tracking sensitivity” item is an item that sets the sensitivity of object track processing. Object track processing is processing for controlling an image capture direction in such a manner as to follow the movement of the object being tracked. A sensitivity may be the amount of movement (e.g., the number of pixels) of the object in an image that triggers a change in the image capture direction, for example. The greater the amount of movement is, the lower the sensitivity becomes, and the smaller the amount of movement is, the higher the sensitivity becomes. Here, five levels of sensitivity corresponding to five predetermined amounts of movement are set. “1” represents the lowest sensitivity, and “5” represents the highest sensitivity.

In the examples shown in FIGS. 3A and 3B, each sub camera can be set a role whose “name” is “main follow”, “main counter”, “assist follow” or “assist counter”. When there are a plurality of sub cameras, a role can be set for each of the sub cameras. When there are a plurality of sub cameras, the control content can be set for each of the sub cameras.

The camera set the role (role ID “1”) for the type “main” and the name “main camera” is handled as a main camera by the image capture control apparatus 100.

For the camera set the role (role ID “2”) for the type “sub” and the name “main follow”, the image capture control apparatus 100 (the CPU 106) sets the same object to be tracked as that of the main camera. In addition, when the angle of view of the main camera changes, the image capture control apparatus 100 applies, to the control target camera, zoom control in the same direction as the zoom of the main camera. Here, “zoom control in the same direction” refers to the zoom direction (telephoto direction or wide-angle direction) being the same, in other words, the direction of a change in the angle of view being the same. Therefore, when zooming-in of the main camera is detected, the image capture control apparatus 100 controls the control target camera to zoom in. “Zooming in” refers to changing the angle of view in the telephoto direction (tele end).

On the other hand, the opposite direction refers to the zoom direction (telephoto direction or wide-angle direction) being opposite, in other words, the direction of a change in the angle of view being opposite. Therefore, when zooming-in of the main camera is detected, the image capture control apparatus 100 controls the control target camera to zoom out. Zooming out refers to changing the angle of view in the wide-angle direction (wide end).

Note that zoom control of each sub camera is only specified in terms of direction, and the angle of view does not need to be the same between the main camera and the sub camera. In addition, for both zoom control in the same direction and zoom control in the opposite direction, the degree of change in the angle of view of the control target camera (such as a change speed or a change rate) does not need to match the degree of change in the angle of view of the main camera.

Furthermore, when performing zoom control by scaling an image, zooming in can be realized by reducing an area that is extracted from the image and then increasing the magnification ratio of the extracted area. In addition, zooming out can be realized by enlarging an area to be extracted from the image and then decreasing the magnification ratio of the extracted area.

For the camera set the role (role ID “3”) for the type “sub” and the name “main counter”, the image capture control apparatus 100 (CPU 106) sets the same object to be tracked as the main camera. In addition, if the angle of view of the main camera changes, the image capture control apparatus 100 applies, to the control target camera, zoom control in the opposite direction to the zoom direction of the main camera.

For the camera set the role (role ID “4”) for the type “sub” and the name “assist follow”, the image capture control apparatus 100 (CPU 106) sets a different object to be tracked from that of the main camera. In addition, when the angle of view of the main camera changes, the image capture control apparatus 100 applies, to the control target camera, zoom control in the same direction as the zoom direction of the main camera.

For the camera set the role (role ID “5”) for the type “sub” and the name “assist counter,” the image capture control apparatus 100 (CPU 106) sets a different object to be tracked from that of the main camera. In addition, when the angle of view of the main camera changes, the image capture control apparatus 100 applies, to the control target camera, zoom control in the opposite direction to the zoom direction of the main camera.

Here, an object located to the left of the object of interest of the main camera in an image is set as an object to be tracked by the sub cameras set the roles for the names “assist follow” and “assist counter”. Note that the object to be tracked by each of the sub cameras set such roles may be set under different conditions. For example, an object located to the right, above, or below the object of interest of the main camera in an image may be set as an object to be tracked. Alternatively, an object being the closest or the farthest among objects other than the object of interest of the main camera may be set as an object to be tracked.

In addition, the image capture control apparatus 100 may execute only one of setting an object to be tracked and zoom control, and may perform control of other items.

Further, FIG. 3B shows a definition list for virtual cameras. The definition list for virtual cameras can be stored in the ROM 115 of the role control apparatus 101 in the table format shown in FIG. 3B, for example. In the present embodiment, four virtual cameras are defined, but the number of virtual cameras defined is not limited to four and may be greater or less than four.

Virtual camera IDs are identification information for the virtual cameras. Camera names are names that can be set such that the user can easily identify the virtual cameras. For example, by a camera name including an envisioned installation location or the like, the camera name can be easily associated with a physical camera. The camera name is displayed together with the virtual camera ID on a role setting screen or the like of the virtual camera. Model names are the model names of physical cameras that are to be associated with the virtual cameras.

Returning to the description of the role setting screen 250A, a drop-down list 200 is a GUI item for selecting (switching to) one role set to be applied from role sets that have been set. The role sets are information (first information) that indicates the correspondence relationship between individual virtual cameras and roles. By preparing, in advance, multiple role sets each having different correspondence relationship between virtual camera and role, and switching the role set using the drop-down list 200, the correspondence relationship between virtual cameras and roles can be changed collectively.

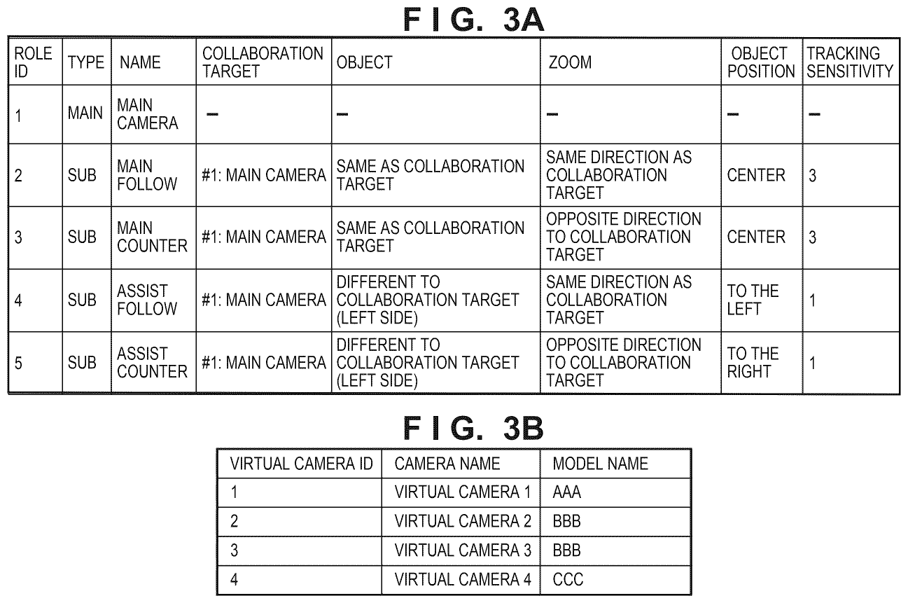

An execute button 201 is a GUI item for giving an instruction to start image capture control in accordance with the role set selected in the drop-down list 200. When operation performed on the execute button 201 is detected, the CPU 114 of the role control apparatus 101 reads information regarding the role definition list (FIG. 3A), a physical camera list (FIG. 4B), and the role set selected in the drop-down list 200 from the ROM 115. The CPU 114 then transmits the read information to the image capture control apparatus 100. The image capture control apparatus 100 refers to the physical camera list to specify virtual cameras associated with the respective physical cameras. The image capture control apparatus 100 then refers to the role set to specify the roles set to the specified virtual cameras, and starts controlling operations of the corresponding physical camera in accordance with the specified role.

A stop button 210 is a GUI item for stopping image capture control. When operation performed on the stop button 210 is detected, the CPU 114 of the role control apparatus 101 instructs the image capture control apparatus 100 to stop image capture control. The image capture control apparatus 100 stops operation control of the sub cameras in accordance with the stop instruction.

A save button 202 is a GUI item for saving the statuses of the items on the role setting screen 250A. When operation performed on the save button 202 is detected, the CPU 114 of the role control apparatus 101 reflects the statuses of a role setting list 203 and a role definition list 205 on the role setting screen 250A at that point in time in the lists stored in the ROM 115.

FIG. 4A is a diagram showing an example of stored role sets. Here, an example is illustrated in which two role sets are stored, but any number of role sets may be stored. When operation is performed on the save button 202 on the role setting screen 250A, the setting content at the point in time when the operation was performed on the save button 202 is reflected in the content of the role set selected in the drop-down list 200. Role set IDs are identification information for the role sets. For each role set, the correspondence relationship between a virtual camera ID and a set role ID is shown.

The role setting list 203 is a GUI item that displays, in an editable manner, the correspondence relationship between information regarding virtual cameras and the roles set thereto. Here, as the information regarding the virtual cameras, virtual camera IDs, camera names, and model names are illustrated, but other items may also be included. The virtual cameras displayed in the role setting list 203 correspond to the definition list of virtual cameras shown in FIG. 3B.

A role field is a drop-down list, and the roles defined in the role definition list 205 are displayed as candidates. A role selected from the drop-down list is set for the corresponding virtual camera.

An input region 204 is a region for inputting information regarding a virtual camera. For the virtual camera corresponding to the row currently selected in the role setting list 203, a camera name and a model name can be input. Here, a configuration is adopted in which a model name is input using a drop-down list for selecting a model name from predetermined model name candidates, but a configuration may also be adopted in which a model name is input by another method.

The role definition list 205 is a GUI item for displaying, in an editable manner, a list of defined roles. For convenience of illustration, some items are not illustrated in the figure, but items (excluding the role ID) of the role definition list shown in FIG. 3A can be edited for each row through an input region 206.

The input region 206 includes GUI items for defining a role for the row currently selected in the role definition list 205. Here, in the input region 206, drop-down lists for selecting content are provided for the respective items of the role definition list shown in FIG. 3A except for the role ID. Note that, for convenience, a drop-down list for setting a tracking sensitivity is not illustrated, but is actually present. Note that, when “main” is selected in the “type” drop-down list, the drop-down lists for the items that only the roles for the type “sub camera” have, such as “collaboration target” and “object”, are disabled.

Note that the numbers of rows in the role setting list 203 and the role definition list 205 are not limited to those illustrated, and can be increased or decreased in accordance with a user instruction.

Next, the camera management screen 250B shown in FIG. 2B will be described. The camera management screen is assumed to be used in a state where the role control apparatus 101 is incorporated into an image capture system at an image capture site (an online state). However, when IP addresses that are set in physical cameras are known in advance, the camera management screen can also be used in a state where the role control apparatus 101 is not incorporated into the image capture system (an offline state).

The camera management screen 250B includes a physical camera list 207 that displays, in an editable list form, correspondence relationship between physical cameras and virtual cameras. The physical camera list 207 is information (second information) indicating the correspondence relationship between each physical camera (an identification number (physical camera ID), a network address (IP address), a username, and a password) and a corresponding virtual camera ID. Note that, for convenience, items for the username and the password are not shown in the figure.

An input region 208 includes GUI items for editing information regarding a physical camera for the row currently selected in the physical camera list 207. Here, in the input region 208, text boxes for inputting an IP address, a username, and a password are provided. The items editable in the input region 208 correspond to the items of the physical camera list to be described later.

A save button 209 is a GUI item for saving the statuses of the items of the physical camera list 207. When operation performed on the save button 209 is detected, the CPU 114 of the role control apparatus 101 saves, in the ROM 115, the statuses of the items of the physical camera list 207 at that point in time.

FIG. 4B shows the physical camera list (second information) stored in the ROM 115 of the role control apparatus 101 and the ROM 107 of the image capture control apparatus 100. The physical camera list shows the correspondence relationship between virtual cameras and information regarding physical cameras installed at the image capture site and registered in the image capture system. When operation is performed on the save button 209 on the camera management screen 250B, the content of the physical camera list 207 is reflected in this list.

A physical camera ID is identification information of a physical camera. An IP address is a network address of the physical camera within a communication system. A username is a username required to access the physical camera. A password is a password required for the user designated by the username to access the physical camera. In addition, a virtual camera ID is associated with each physical camera. Here, a state is illustrated in which virtual cameras have been respectively associated with all the physical cameras through operation performed on the pull-down list of the physical camera list 207 shown in FIG. 3B.

Using the role setting screen 250A, the roles are set to the virtual cameras that are assumed to be physical cameras. Then, after installation of the physical cameras at the image capture site is completed, the correspondence relationship between the virtual cameras and the physical cameras is set using the camera management screen 250B, thereby completing role setting. Thus, it is possible to significantly reduce the effort and time required for setup processing at the image capture site.

In addition, a role set in which the roles are set to the virtual cameras is used, and thus, the same role set can be used in cases where the number of physical cameras and arrangement of the physical cameras are the same and the roles set to the cameras are also the same such as where similar types of image capturing are performed in different studios. Thus, compared with a case where the roles are directly set to the respective physical cameras, it is possible to significantly reduce the effort and time required for role setting.

### Role Setting Operation on Virtual Camera

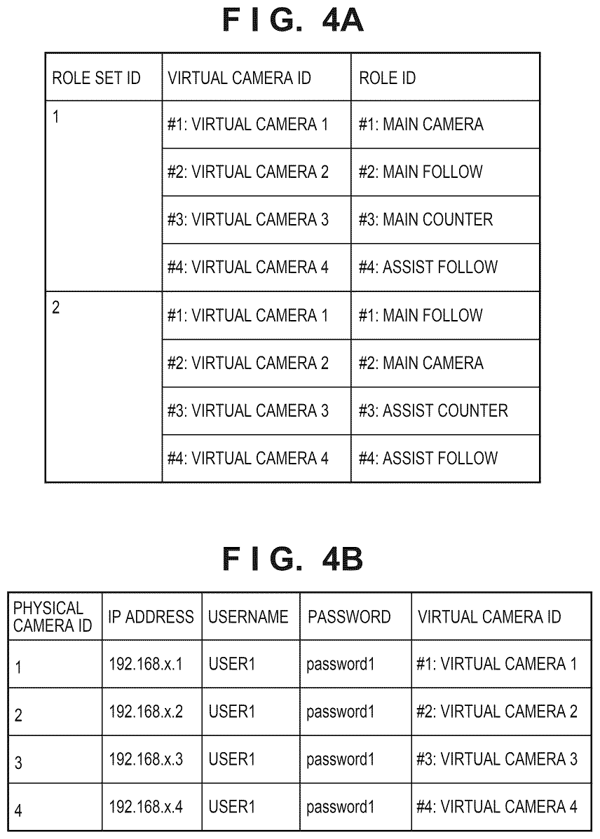

FIG. 5 is a flowchart related to a role setting operation that is executed on a virtual camera by the role control apparatus 101. Operations described later are executed, for example, through selection on an application menu while the role setting screen 250A is displayed.

In step S500, the CPU 114 determines whether or not operation performed on the role setting screen 250A has been detected, and executes step S501 again if it is determined that such operation has been detected, and executes step S500 again if not.

In step S501, the CPU 114 determines whether the operation performed on the role setting screen 250A is operation on the execute button 201, the stop button 210, or the save button 202. If it is determined that the operation on the role setting screen 250A is operation on the execute button 201, the stop button 210, or the save button 202, the CPU 114 executes step S503, and otherwise executes step S502.

In step S502, the CPU 114 executes a process corresponding to the detected operation. For example, if the detected operation is a click on the role setting list 203, the row corresponding to the operation position enters a selected state, and the display of the content in the input region 204 is changed to content corresponding to the selected row. In addition, if the detected operation is operation on an item in the input region 204 or 206, the CPU 114 updates the display of the corresponding role setting list 203 or role definition list 205 in accordance with the operation. Furthermore, when the role set is switched through operation on the drop-down list 200, the CPU 114 switches the display of the role setting list 203 to correspond to the newly selected role set. The CPU 114 then executes step S500 again.

In step S503, the CPU 114 determines whether or not the operation on the role setting screen 250A is operation on the save button 202. The CPU 114 executes step S504 if it is determined that the operation on the role setting screen 250A is operation on the save button 202, and executes step S505 if not.

In step S504, the CPU 114 reflects the statuses of the role setting list 203 and the role definition list 205 on the role setting screen 250A at the time in time when the operation was performed on the save button 202, in the lists stored in the ROM 115. The CPU 114 then executes step S500 again.

In step S505, if the detected operation is operation on the execute button 201, the CPU 114 reads out, from the ROM 115, the role definition list (FIG. 3A), the physical camera list (FIG. 4B), and information regarding the role set selected in the drop-down list 200. The CPU 114 then transmits the read information to the image capture control apparatus 100.

Note that the execute button 201 can be enabled for operation only when the role control apparatus 101 is in an online state and the virtual cameras have been associated with the physical cameras on the camera management screen 250B.

When the user desires to change the role set for use during image capturing, for example, the user performs operation on the drop-down list 200 to bring a desired role set into a selected state, and then performs operation on the execute button 201. When operation is performed on the execute button 201, the CPU 114 transmits information regarding the selected role set to the image capture control apparatus 100. The image capture control apparatus 100 then changes the operation control of the physical cameras in accordance with the newly received role set. In this manner, by setting a plurality of role sets in advance, content of control of the physical cameras performed by the image capture control apparatus 100 can be dynamically and easily changed.

In addition, if the detected operation is operation on the stop button 210, the CPU 114 instructs the image capture control apparatus 100 to stop image capture control. Note that the stop button 210 is enabled for operation only when the role control apparatus 101 is in an online state and operation control of the physical cameras is being executed by the image capture control apparatus 100. The CPU 114 then executes step S500 again.

Setting the roles to the virtual cameras on the role setting screen 250A does not require physical cameras and can be executed even when the role control apparatus 101 is in an offline state. Thus, before constructing the image capture system at the image capture site (when the role control apparatus 101 is in the offline state), the user can set the roles to the virtual cameras and store them as one or more role sets. Thus, it is possible to reduce the effort and time required to set roles after installation and registration of the physical cameras at the image capture site.

### Operation of Associating Virtual Cameras With Physical Cameras

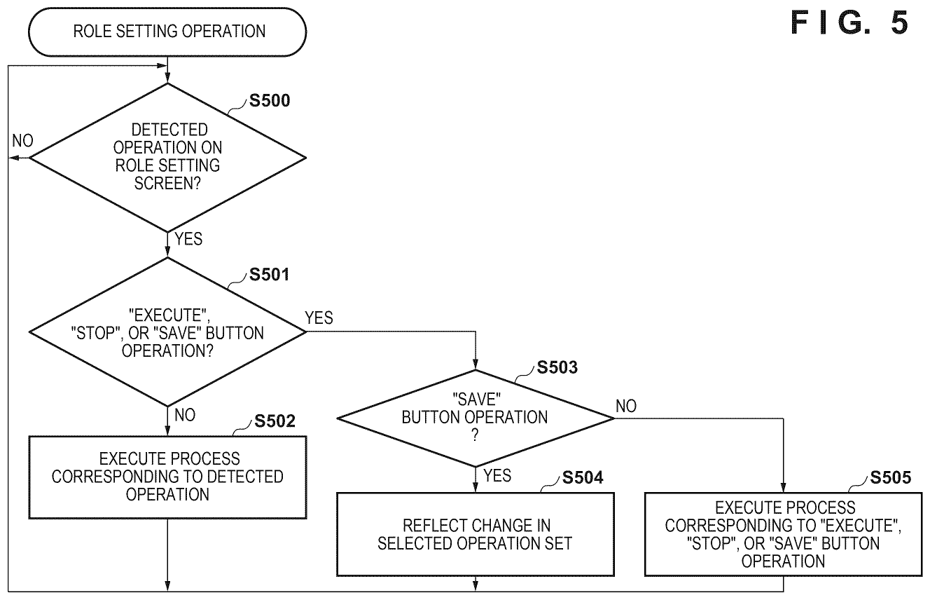

Next, operation of associating the virtual camera with the physical camera will be described with reference to the flowchart shown in FIG. 6. Association of the virtual cameras with the physical camera is executed in a state where the role control apparatus 101 is incorporated into the image capture system at the image capture site, i.e., in a state where the role control apparatus 101 is in an online state. The operation to be described later is executed when the camera management screen 250B is displayed, for example, through selection on an application menu.

In step S601, the CPU 114 determines whether or not operation performed on the camera management screen 250B has been detected, and executes step S602 if it is determined that such operation has been detected, and executes step S601 again if not.

In step S602, the CPU 114 determines whether or not the operation on the camera management screen 250B is operation on the save button 209, and executes step S604 if it is determined that the operation was operation on the save button 209, and executes step S603 if not.

In step S604, the CPU 114 reflects the status of the physical camera list 207 at the time point when the operation was performed on the save button 209, in the list stored in the ROM 115. The CPU 114 then executes step S601 again.

In step S603, the CPU 114 executes a process corresponding to the detected operation. For example, if the detected operation is a click on the physical camera list 207, the row corresponding to the operation position enters a selected state, and the display of the content in the input region 208 is changed to content corresponding to the selected row. In addition, if the detected operation is operation on the “virtual camera ID” drop-down list, the CPU 114 updates the selected content in the in drop-down list in accordance with the operation. Furthermore, if the detected operation is an input operation in the input region 208, the CPU 114 updates the display of the corresponding physical camera list 207 in accordance with the operation. The CPU 114 then executes step S601 again.

By inputting information regarding a physical camera to the physical camera list 207 when the role control apparatus 101 is in an online state, the user registers the physical camera to the image capture system. Alternatively, information regarding a physical camera may be automatically input to the physical camera list 207 by registering the physical camera in the image capture control apparatus 100, and the CPU 114 obtaining information regarding the registered physical camera from the image capture control apparatus 100.

In either case, the user uses the pull-down list of the physical camera list 207 to associate each physical camera with one virtual camera. The virtual cameras are associated with the physical cameras in a one-to-one relationship. That is, a plurality of physical cameras cannot be associated with the same virtual camera, nor can a single physical camera be associated with a plurality of virtual cameras.

The operation of each physical camera is controlled by the image capture control apparatus 100 in accordance with the role set to the virtual camera associated with the physical camera. In addition, the role set to the virtual camera is specified by the role set currently in use.

As described above, the role set used by the image capture control apparatus 100 to control the physical cameras is transmitted to the image capture control apparatus 100 together with the role definition list in accordance with operation performed on the execute button 201 on the role setting screen 250A. Therefore, at the image capture site, after associating the physical cameras with the virtual cameras on the camera management screen 250B, the user switches the screen to the role setting screen 250A and performs operation on the execute button 201, thereby enabling the image capture control apparatus 100 to start image capture control.

### Specific Examples of Operation Control of Physical Cameras Performed by Image Capture Control Apparatus 100

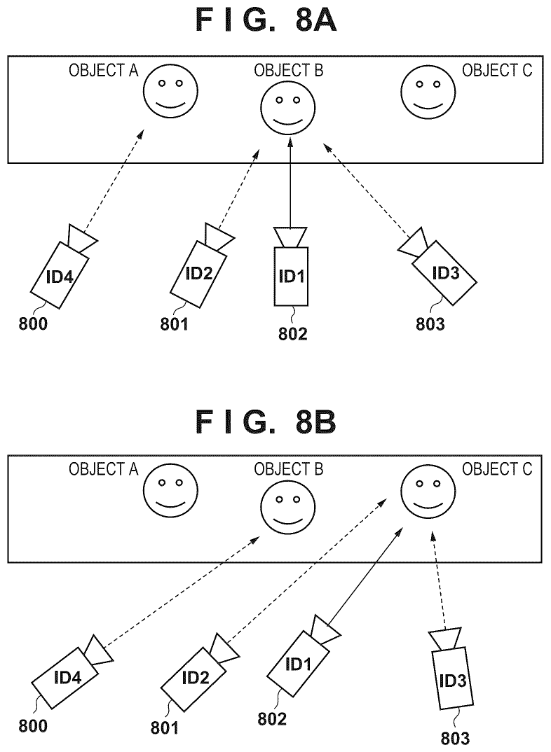

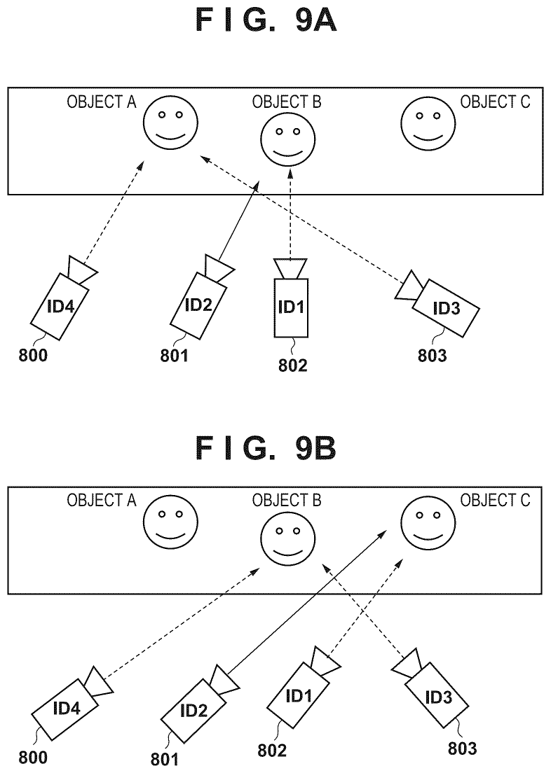

Specific examples of operation control of physical cameras in which a role set for virtual cameras is used will be described with reference to FIGS. 8A to 9B.

FIGS. 8A and 8B are diagrams schematically showing an example of operation control of physical cameras performed by the image capture control apparatus 100 using the role set with the role set ID “1” shown in FIG. 4A. Here, assume that a camera 800 corresponds to a physical camera ID “4”, a camera 801 corresponds to a physical camera ID “2”, a camera 802 corresponds to a physical camera ID “1”, and a camera 803 corresponds to a physical camera ID “3”.

Based on the physical camera list (FIG. 4B), the camera 800 is associated with a virtual camera 4. In addition, in the role set ID “1”, the role “assist follow” is set to the virtual camera 4.

Similarly, the camera 801 is associated with a virtual camera 2, and the role “main follow” is set to the virtual camera 2. The camera 802 is associated with a virtual camera 1, and the role “main camera” is set to the virtual camera 1. The camera 803 is associated with a virtual camera 3, and the role “main counter” is set to the virtual camera 3.

In the image capture scene shown in FIG. 8A, the camera 802 set the role “main camera” is operated, for example, by a cameraman to capture an image of an object B. The CPU 106 of the image capture control apparatus 100 detects a zoom operation of the camera 802 and the object of interest (the object B) of the camera 802. The object of interest can be detected from a moving image captured by the camera 802 using a known method.

The CPU 106 controls the operation of the camera 801 set the role “main follow” in accordance with the content of the items corresponding to the name “main follow” in the role definition list (FIG. 3A). Specifically, the CPU 106 controls the image capture operation of the camera 801 to perform image capturing such that the object of interest (the object B) of the main camera is positioned at the center of the screen and to perform processing for tracking the object B with a sensitivity level 3. In addition, when a zoom operation of the main camera is detected, the CPU 106 controls the camera 801 to perform a zoom operation in the same direction as the zoom operation of the main camera.

The CPU 106 controls the operation of the camera 803 set the role “main counter” in accordance with the content of the items corresponding to the name “main counter” in the role definition list (FIG. 3A). Specifically, the CPU 106 controls the image capture operation of the camera 803 to perform image capturing such that the object of interest (the object B) of the main camera is positioned at the center of the screen, and to perform processing for tracking the object B with the sensitivity level 3. In addition, when a zoom operation of the main camera is detected, the CPU 106 controls the camera 803 to perform a zoom operation in the opposite direction to the zoom operation of the main camera.

The CPU 106 controls the operation of the camera 800 set the role “assist follow” in accordance with the content of the items corresponding to the name “assist follow” in the role definition list (FIG. 3A). Specifically, the CPU 106 controls the image capture operation of the camera 800 to perform image capturing such that an object (an object A) that is other than the object of interest (the object B) of the main camera and is located to the left of the object B is positioned on the left side of the screen, and to perform processing for tracking the object A with a sensitivity level 1. In addition, when a zoom operation of the main camera is detected, the CPU 106 controls the camera 800 to perform a zoom operation in the same direction as the zoom operation of the main camera.

As shown in FIG. 8B, when the object of interest of the main camera 802 changes to an object C, the CPU 106 changes operation control of the sub cameras 800, 801, and 803 as follows.

The CPU 106 controls the operation of the camera 801 set the role “main follow” in accordance with the content of the items corresponding to the name “main follow” in the role definition list (FIG. 3A). Specifically, the CPU 106 controls the image capture operation of the camera 801 to perform image capturing such that the object of interest (the object C) of the main camera is positioned at the center of the screen, and to perform processing for tracking the object C with the sensitivity level 3. In addition, when a zoom operation of the main camera is detected, the CPU 106 controls the camera 801 to perform a zoom operation in the same direction as the zoom operation of the main camera.

The CPU 106 controls the operation of the camera 803 set the role “main counter” in accordance with the content of the items corresponding to the name “main counter” in the role definition list (FIG. 3A). Specifically, the CPU 106 controls the image capture operation of the camera 801 to perform image capturing such that the object of interest (the object C) of the main camera is positioned at the center of the screen and to perform processing for tracking the object C with the sensitivity level 3. In addition, when a zoom operation of the main camera is detected, the CPU 106 controls the camera 801 to perform a zoom operation in the opposite direction to the zoom operation of the main camera.

The CPU 106 controls the operation of the camera 800 set the role “assist follow” in accordance with the content of the items corresponding to the name “assist follow” in the role definition list (FIG. 3A). Specifically, the CPU 106 controls the image capture operation of the camera 800 to perform image capturing such that an object (the object B) that is other than the object of interest (the object C) of the main camera and is located to the left of the object C is positioned on the left side of the screen, and to perform processing for tracking the other object B with the sensitivity level 1. In addition, when a zoom operation of the main camera is detected, the CPU 106 controls the camera 800 to perform a zoom operation in the same direction as the zoom operation of the main camera.

When the role set used by the image capture control apparatus 100 is changed from ID1 to ID2 in the state in FIG. 8A, the image capture control apparatus 100 controls the operations of the cameras as shown in FIG. 9A.

With the role set ID2, the virtual camera 1 is set the role “main follow”, the virtual camera 2 is set the role “main camera”, the virtual camera 3 is set the role “assist counter”, and the virtual camera 4 is set the role “assist follow”.

There is no change in the correspondence relationship between the physical cameras and the virtual cameras. Thus, the CPU 106 performs control so as to switch the camera 801 to the main camera, and operate the camera 800 in accordance with the role “assist follow”, the camera 803 in accordance with the role “assist counter”, and the camera 802 in accordance with the role “main follow”.

The CPU 106 executes operation control of the camera 800 in accordance with the items of the role “assist follow”. Since the main camera is changed from the camera 802 to the camera 801, the CPU 106 controls the image capture operation of the camera 800 to perform image capturing such that an object (the object A) that is other than the object of interest (object B) of the camera 801 and is located to the left of object B is positioned on the left side of the screen, and to perform processing for tracking the object A with the sensitivity level 1. In addition, when a zoom operation of the camera 801 is detected, the CPU 106 controls the camera 800 to perform a zoom operation in the same direction as the zoom operation of the camera 801.

The CPU 106 controls the image capture operation of the camera 802 set the role “main follow” to perform image capturing such that the object of interest (the object B) of the camera 801 is positioned at the center of the screen, and to perform processing for tracking the object B with the sensitivity level 3. In addition, when a zoom operation of the camera 801 is detected, the CPU 106 controls the camera 802 to perform a zoom operation in the same direction as the zoom operation of the camera 801.

The CPU 106 controls the image capture operation of the camera 803 set the role “assist counter” to perform image capturing such that an object (the object A) that is other than the object of interest (object B) of the camera 801 and is located to the left of the object B is positioned on the left side of the screen, and to perform processing for tracking the object A with the sensitivity level 1. In addition, when a zoom operation of the camera 801 is detected, the CPU 106 controls the camera 803 to perform a zoom operation in the opposite direction to the zoom operation of the camera 801.

When the object of interest of the main camera 801 changes from the object B to the object C from the state FIG. 9A as shown in FIG. 9B, the CPU 106 changes operation control of the sub camera 800, 802, 803 as follows.

The CPU 106 controls the image capture operation of the camera 800 set the role “assist follow” to perform image capturing such that an object (the object B) that is other than the object of interest (object C) of the camera 801 and is located to the left of the object C is positioned on the left side of the screen, and to perform processing for tracking the object B with the sensitivity level 1. In addition, when a zoom operation of the camera 801 is detected, the CPU 106 controls the camera 800 to perform a zoom operation in the same direction as the zoom operation of the camera 801.

The CPU 106 controls the image capture operation of the camera 802 set the role “main follow” to perform image capturing such that the object of interest (object C) of the camera 801 is positioned at the center of the screen, and to perform processing for tracking the object C with the sensitivity level 3. In addition, when a zoom operation of the camera 801 is detected, the CPU 106 controls the camera 802 to perform a zoom operation in the same direction as the zoom operation of the camera 801.

The CPU 106 controls the image capture operation of the camera 803 set the role “assist counter” to perform image capturing such that an object (the object B) that is other than the object of interest (the object C) of the camera 801 and is located to the left of the object C is positioned on the left side of the screen, and to perform processing for tracking the object B with the sensitivity level 1. In addition, when a zoom operation of the camera 801 is detected, the CPU 106 controls the camera 803 to perform a zoom operation in the opposite direction to the zoom operation of the camera 801.

### Modified Example

In the first embodiment, the image capture control apparatus 100 specifies roles for respective physical cameras based on the role definition list, the physical camera list, and a role set. However, roles for respective physical cameras may be specified by the role control apparatus 101 and then transmitted to the image capture control apparatus 100. In this case, it suffices for the CPU 114 to specify the roles for the individual physical cameras in response to operation performed on the “execute” button in step S505 of FIG. 5, and transmit the roles for the respective physical camera to the image capture control apparatus 100.

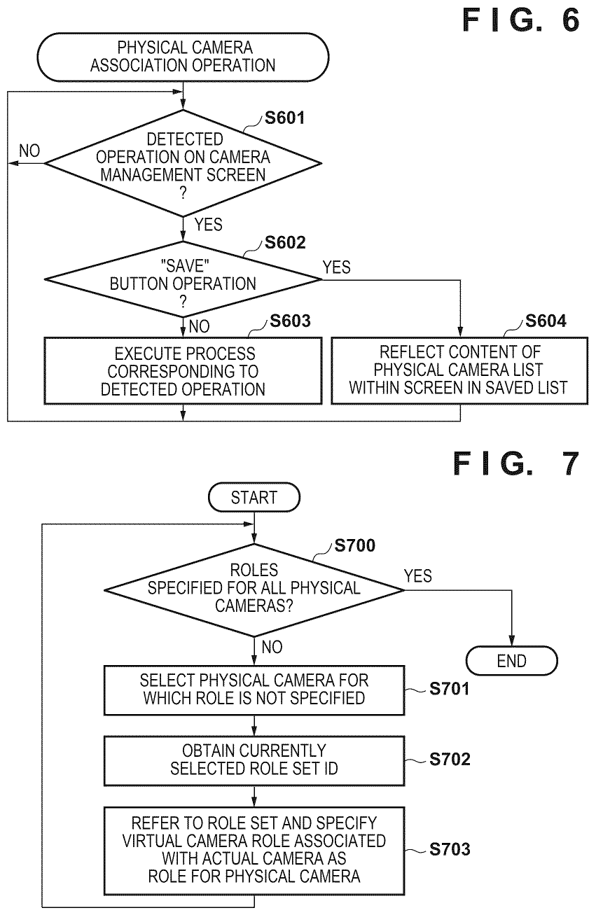

FIG. 7 is a flowchart related to operation of specifying a role for each physical camera.

In step S700, the CPU 114 determines whether or not roles have been respectively specified for all of the physical cameras in the physical camera list. The CPU 114 terminates the processing if it is determined that roles have been specified for all of the physical cameras, and advances the processing to step S701 if not.

In step S701, the CPU 114 selects one physical camera for which no role has been specified.

In step S702, the CPU 114 obtains the currently selected role set ID.

In step S703, the CPU 114 refers to the currently selected role set and specifies the role set to the virtual camera associated with the physical camera.

The CPU 114 can transmit, to the image capture control apparatus 100, for example, a list (fourth information) obtained by changing the “virtual camera ID” item in the physical camera list to a “role” item, together with the role definition list. Note that, also when the image capture control apparatus 100 specifies roles for the respective physical cameras, processing similar to steps S700 to S703 is executed.

By the role control apparatus 101 specifying roles for the physical cameras, it is possible to reduce the amount of processing that is performed by the image capture control apparatus 100.

In addition, in the first embodiment, the role control apparatus 101 and the image capture control apparatus 100 are described as separate apparatuses. However, the role control apparatus 101 may alternatively be implemented as one of functions of the image capture control device 100. In other words, the role control apparatus 101 and the image capture control apparatus 100 are implemented in the same apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and/or the like.

While the present disclosure has been described with reference to example embodiments, it is to be understood that the present disclosure is not limited to the disclosed example embodiments. The scope of the following claims is to be accorded the broadest interpretation so as to encompass all such modifications and equivalent structures and functions.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It will be understood that the terms “first”, “second”, and “third”, or the like may be construed merely as labels and do not necessarily indicate an order or a sequence. For example, third information may be provided in combination with or not in combination with second information. As another example, where the label “third” has been used the label “second” may be used in its place, and vice versa.

This application claims the benefit of Japanese Patent Application No. 2024-196926, filed Nov. 11, 2024, which is hereby incorporated by reference herein in their entirety.

What is claimed is:

1. A role control apparatus that controls operation of a physical camera in accordance with a role set thereto, the role control apparatus comprising one or more processors that execute a program stored in a memory and thereby function as units including:
a first generation unit configured to generate first information indicating a correspondence between a plurality of virtual cameras and respective roles set thereto; and
a second generation unit configured to generate third information indicating definitions of the roles.

2. The role control apparatus according to claim 1, wherein the units further including:
a third generation unit configured to generate second information indicating a correspondence relationship between a plurality of physical cameras and the plurality of virtual cameras.

3. The role control apparatus according to claim 1,
wherein, among the third information indicating definitions of the roles, information indicating a definition of a first role for performing operation collaborating with another camera includes one or more of:
whether or not to set an object of interest of the other camera as an object to be tracked;
a position of the object to be tracked on a screen;
a sensitivity of object tracking processing; and
whether to set a same zoom direction as or an opposite zoom direction to a zoom direction of the other camera.

4. The role control apparatus according to claim 3, further comprising:
a display device that displays a settings screen in which, for each of the roles, the other cameras can be set.

5. The role control apparatus according to claim 1, further comprising:
a display device that displays a setting screen in which one of the roles can be set to one or more of the plurality of virtual cameras.

6. The role control apparatus according to claim 1, further comprising:
a storage device that stores a plurality of pieces of the first information, each of which indicating a different combination of correspondences between the plurality of virtual cameras and the roles assigned to the respective virtual cameras; and
wherein the units further include a selection unit configured to select one of the plurality of pieces of first information selected in response to a user operation.

7. The role control apparatus according to claim 1,
wherein the roles include a role for a sub camera and a role for a main camera.

8. The role control apparatus according to claim 1, wherein the units further including:
a transmission unit configured to transmit the first information and the third information to an external apparatus that controls operations of a plurality of physical cameras.

9. The role control apparatus according to claim 2, wherein the units further including:
a transmission unit configured to transmit the first information, the third information and the second information to an external apparatus.

10. The role control apparatus according to claim 6, wherein the units further including:
a transmission unit configured to transmit, to the external apparatus, the one of the plurality of pieces of first information selected by a user.

11. An image capture system comprising:
a plurality of physical cameras;
the role control apparatus according to claim 1; and
an apparatus that controls operation of each of the plurality of physical cameras according to a role set thereto, based on the first information and the third information transmitted from the role control apparatus.

12. A role control method for controlling operation of a physical camera in accordance with a role set thereto, the role control method comprising:
generating first information indicating a correspondence between a plurality of virtual cameras and respective roles set thereto; and
generating third information indicating definitions of the roles.

13. A non-transitory computer-readable medium storing a program that, when executed by one or more processors, causes the one or more processors to perform a role control method for controlling operation of a physical camera in accordance with a role set thereto, the role control method comprising:
generating first information indicating a correspondence between a plurality of virtual cameras and respective roles set thereto; and
generating third information indicating definitions of the roles.
